(19) United States
(12) Patent Application Publication
(10) Pub. No.: US 2007/0063969 A1
(43) Pub. Date: Mar. 22, 2007

(54) Single finger micro controllers for portable electronic device

(76) Inventor: Christopher Wright, San Francisco, CA (US)

Correspondence Address: DERGOSITS & NOAH LLP, FOUR EMBARCADERO CENTER, SUITE 1450, SAN FRANCISCO, CA, 94111, US

(21) Appl. No.: 11/257,842

(22) Filed: Oct. 25, 2005

Related U.S. Application Data
(60) Provisional application No. 60/717,797, filed on Sep. 15, 2005.

(51) Int. Cl. G09G 5/00

(52) U.S. Cl. 345/156; 345/645

(57) ABSTRACT

A portable electronic device that can be held in one hand includes a graphical display and an input device that is mounted on a surface opposite the graphical display. The input device can be operated with the user's index finger. This configuration is very space efficient and allows the user to view the graphical display and control the device with either the user's left or right hand.

### CROSS-REFERENCE TO RELATED APPLICATIONS

The application claims priority to U.S. Provisional Application No. 60/717,797 for SINGLE FINGER MICRO CONTROLLERS, filed on Sep. 15, 2005.

### BACKGROUND

Most portable electronic devices include input devices which allow the user to control the operation of the device. Devices such as: telephones, portable audio devices, video games, remote controls, personal digital assistants (PDAs) and computers have input mechanisms including: control buttons, numeric keypads, keyboards, touchpads, trackballs, joysticks that are controlled by user's fingers. Many of these portable electronic devices also include a graphical display that is mounted on the same side of the device as the input mechanism.

The user typically holds the device with one hand and operates the input device with the other hand. Alternatively, the user holds the device in the palm of the hand and operates the input device with the thumb. The trend in portable electronic devices is increased functionality with decreased size. This creates a problem of how to fit the display and controls onto a small device that has a limited surface area. What is needed is an input device that efficiently utilizes the space on a portable electronic device.

### SUMMARY OF THE INVENTION

The inventive portable electronic device can be held with one hand and allows the user to control the operations through an input mechanism mounted opposite a graphical display. The device can be held between the user's fingers and thumb while the user's index finger controls an input device on the back of the device. This configuration allows the user to view the graphical display while using the input device. The input device may be a roller ball, a slider, a touch pad, a roller or any other small mechanism that can detect the movement of the user's fingertip.

The input device controls the movement of a cursor over the graphical display of the device. If the input device is moved towards the upper right side of the device, the cursor is moved towards the upper right of the graphical display. If the input device is moved towards the lower left, the cursor is moved to the lower left of the graphical display. The input device may also have a click feature that allows the user to place the cursor over a command or icon and actuate the command by clicking the input device. In an alternative embodiment, the input device controls the movement of a highlight feature rather than a cursor.

### BRIEF DESCRIPTION OF THE DRAWINGS

The invention is herein described, by way of example only, with reference to embodiments of the present invention illustrated in the accompanying drawings, wherein:

FIG. 1 is front view of a mobile phone;

FIG. 2 is a back view of a mobile phone with a roller ball;

FIG. 3 is a front view of a clamshell type mobile phone;

FIG. 4 is a back view of a clamshell type mobile phone with a roller ball;

FIG. 5 is a side view of the roller ball;

FIG. 6 is a back view of a mobile phone with a rocker switch;

FIGS. 7a-7e are side views of the rocker switch movement;

FIG. 8 is a back view of a mobile phone with a planar slide switch;

FIGS. 9a-9e are top views of the planar slide switch movement;

FIGS. 10a-10d are top views of a spherical slide switch movement;

FIG. 11 is a back view of a mobile phone with a touch pad;

FIG. 12 is a back view of a mobile phone with a roller input device;

FIG. 13 is a front view of a portable digital device;

FIG. 14 is a back view of a portable digital device with a roller ball;

FIG. 15 illustrates the portable digital device used with a computer;

FIG. 16 illustrates the portable digital device used with a vehicle; and

FIG. 17 illustrates the portable digital device used with a projector display.

### DETAILED DESCRIPTION

As portable electronic devices get smaller in size, surface area of the input device also decreases. The display and controls of the device must be efficiently placed on the portable electronic device to allow the user to both hold and easily operate the electronic device, preferably with one hand. The present invention is directed towards a small portable electronic device that includes a graphical display on one side and an input device on the opposite side. This configuration allows the user to operate the input device while observing the graphical display. The input device may be used in combination with other input devices mounted on the same side of the device as the graphical display. In this configuration, the user can hold the device in one hand and view the display while operating the controls on the front of the device with the thumb and operate the input device on the back with the index finger.

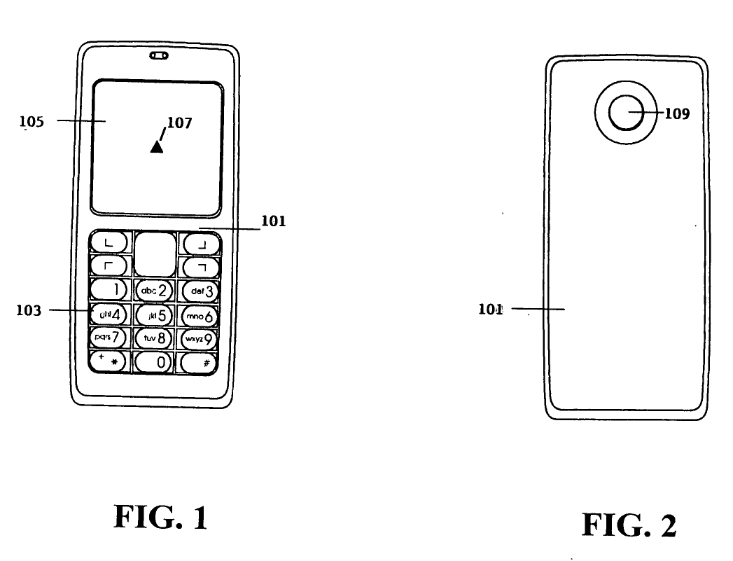

Examples of the input device are illustrated in FIGS. 1-5 in mobile phone applications. Although mobile phones are illustrated, it is well understood that the input devices can be used with any other type of portable electronic device including: PDAs, cameras, portable audio/video devices, remote control devices, computer interfaces and other devices that can be held with a single hand.

In the preferred embodiment, the inventive portable electronic device may be an elongated structure that can fit comfortably in a normal human hand. The width may be about 1.25 to 4.00 inches in width, 3.00 to 6.00 inches in length and 0.10 to 1.00 inch thick. For portability, the device should also be very light in weight between about 0.5 to 10 ounces. For easy operation, the device should have edges that easily held between the user's thumb and fingers. Although smooth plastic and metal are common materials for consumer electronic devices, the sides of the inventive device may have a textured finish that helps the user grip the edges of the device and operate the small input mechanism.

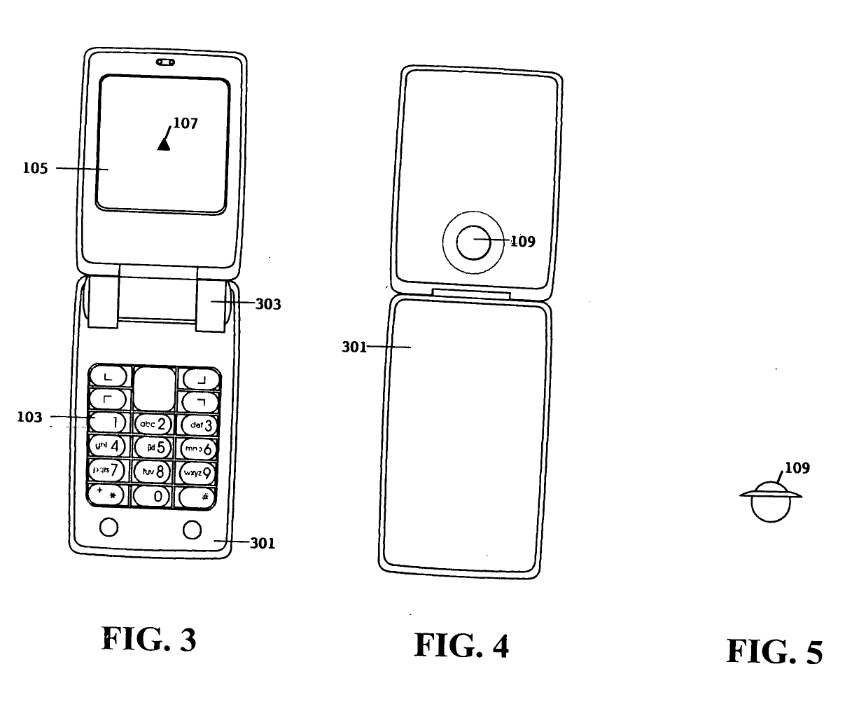

With reference to FIG. 1, a front view of a mobile telephone 101 is shown. The telephone includes a keypad 103, a graphical display 105, a cursor 107, a microprocessor and a battery. The microprocessor runs a program that controls the movement of the cursor within the graphical display. FIG. 2 is a view of the backside of the telephone 101 showing a roller ball 109 input device and FIG. 3 is a side view of the roller ball 109 in the phone 101. The phone can be held in the user's hand so that the user can see the graphical display 105, press the keypad 103 with the thumb. This configuration allows the user to view the graphical display 105 while operating the roller ball 109 input device. A portion of the roller ball 109 is exposed through a hole in the back side of the telephone 101. To operate the roller ball 109, the edges of the phone are held between the user's thumb and middle, third and little fingers while the index finger contacts and rotates the roller ball 109 input device as it is held within the phone 101.

The one handed capability is also very beneficial to individuals who only have one hand free. This allows the user to easily control the device while the other hand is holding an object or performing another task. The inventive device can also be easily used by people who are physically impaired and only have a single hand available. The symmetric design allows the same product to be used equally well with the left or right hand.

The roller ball 109 is able to rotate in any direction and sensors within the phone 101 detect the direction and speed of the rotation. The sensors transmit the direction and speed information to the microprocessor which runs a program that moves the cursor 107 within the graphical display 105 in response to the movement of the roller ball 109. If the movement of the roller ball 109 is towards the right side of the phone 101, the microprocessor will instruct the cursor 107 towards the right side of the graphical display 105. Similarly, if the roller ball 109 is moved up, down or towards the left side of the phone, cursor 107 will move in the corresponding direction within the graphical display 105. The movement of the user's finger, the roller ball 109 and the cursor 107 are listed in table 1 below.

TABLE 1

| Finger Movement And Rotation of Roller Ball | Cursor Movement |
|---|---|
| towards top of phone | up |
| towards left side of phone | left |
| towards bottom of phone | down |
| towards right side of phone | right |

The roller ball 109 may also have a “click” function that is actuated by pressing the ball 109 into the housing of the phone 101. This feature may allow the roller ball 109 to operate like a computer mouse by allowing the user to move the cursor 107 over a command and then press the ball 109 to click on the command. This clicking function allows the user to position the cursor 107 over a command and then select the command by clicking.

Although the described coordinated movement between the roller ball input device 109 and the cursor 107 is similar to that of a normal roller ball, there are functional differences. If a normal computer track ball was mounted on the back of a device and rolled towards the right side of the device, the cursor would move towards the left within the display. Conversely, if the track ball was rolled towards the left side of the device, the cursor would move towards the right side of the display. There is no suggestion in the prior art for placing a tack ball device opposite the display 105. For these reasons, there is a substantial difference between the operation of the inventive portable electronic device and the roller ball prior art.

In another embodiment, the inventive portable telephone 101 can be used as a computer mouse and portable memory device. The phone 101 may communicate with a computer through a wired connection or through wireless means such as a BlueTooth transceiver. The phone 101 may have low friction pads that support the weight of the phone 101 but allow the roller ball 109 to roll freely against a planar surface. In this embodiment, the phone 101 has a mechanism that senses when the phone 101 is placed against a surface. The mechanism causes the phone 101 to change the mode of operation of the cursor 107. Alternatively, the phone 101 can have a manual switch that changes the mode of operation. In this “mouse” mode of operation, the phone 101 functions like a normal computer mouse. When the telephone 101 moves the right, the roller ball 109 rotates towards the left side of the phone 101 and a signal is transmitted to the computer that causes a cursor to move to the right side of the computer display. This may also causes the cursor 107 to move to the right side of the graphical screen 105. The movement of the phone 101, roller ball 109 and cursor 107 are listed in Table 2 below.

TABLE 2

| Phone Movement | Rotation of Roller Ball | Cursor Movement |
|---|---|---|
| forward | towards bottom of phone | up |
| right | towards left side of phone | right |
| back | towards top of phone | down |
| left | towards right side of phone | left |

The phone 101 may also have digital memory that can be exchanged with the computer. The computer detects the presence of the phone 101 and may have a security system and procedures to prevent unauthorized access to the computer. The user interface of the computer may show the phone as normal external memory device. By clicking on the phone in the interface, the user can store or extract information from the phone 101. This portable memory is useful when the user has access to multiple computers and would like to travel with the electronic documents.

FIGS. 4 and 5 illustrate an alternative embodiment in which the phone 301 is a “clamshell” design which has a center hinge 303. When the phone 301 is flipped open, the keypad 103 and graphical display 105 with cursor 107 are visible to the user. The roller ball 109 is mounted on the opposite side of the graphical display 105. In order to prevent the phone 301 from closing when the roller ball 109 is used, the hinge 303 may have a locking mechanism to hold the phone in the open position. Alternatively, the roller ball 109 may be placed on a lower portion of the phone 301 opposite the keypad 103.

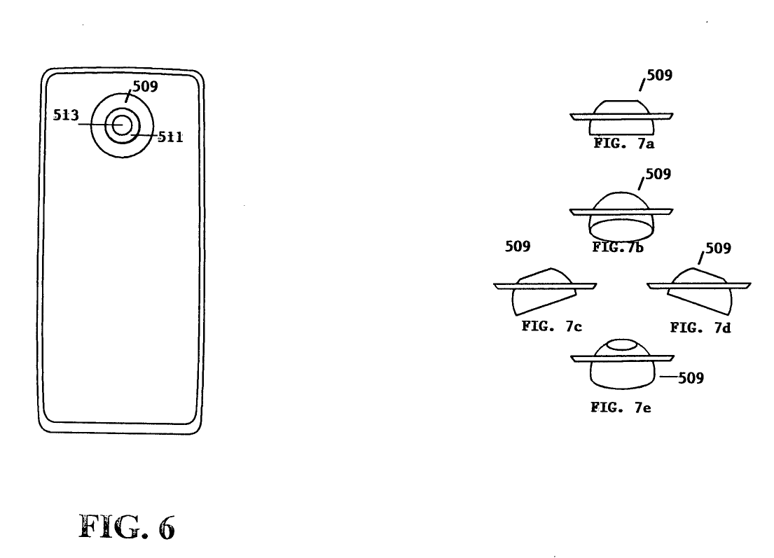

In other embodiments of the present invention, other input devices that are not roller balls can be used. With reference to FIG. 6, a pivoting rocker switch 509 is placed on the back of the phone 501. The switch 509 may have a hemispherical surface 511 with an indentation 513 at the top center. The protrusion is easily sensed by the tip of the index finger and allows the user to quickly place the index finger on the center of the rocker switch 509. In an alternative embodiment, the hemispherical surface 511 may have a small protrusion at the top center. The rocker switch 509 can rotate in any direction but is limited in the range of rotation. For example, the rocker switch 509 may rotate less than about ¼ inch or less than about 20 degrees off center. A spring mechanism holds the switch 509 in a center and neutral position. To operate the switch 509, the user places a finger on the indentation 513 and rotates the surface 511 in a desired direction.

FIGS. 7a-7e illustrate some of the possible movements of the rocker switch 509. If the switch 509 is rotated to the right of the device, the cursor 107 moves towards the right side of the graphical display 105. If the switch 509 is rotated to the left of the device, the cursor 107 moves towards the left side of the graphical display 105. If the switch 509 is moved towards the upper right of the device, the cursor moves towards the upper right. In an embodiment, the movement of the cursor 107 may be proportional to the movement of the switch 509. If the switch 509 is rotated slightly off center, the cursor 107 moves slowly and if the switch 509 is rotated until it stops, the cursor 107 moves faster.

The rocker switch 509 may also have a click function when the switch 509 is pressed into the device. When the user wishes to activate a command, he or she can move the cursor 107 over the command displayed on the graphical display 105 and click the switch 509 to select the desired command. In an embodiment, the click mechanism may be a small protrusion at the center of the rocker switch 509. By pressing the protrusion flush with the surrounding surface of the switch 509 the click mechanism is actuated.

The inventive switch 509 is substantially different in operation than prior art joysticks. If a joystick was mounted on the back of the device, a movement of the stick towards the right side of the device would result in the cursor moving towards the left side of the graphical display 105. There is no suggestion in the prior art for placing the input device opposite the display 105 and it would also be impractical to place a joystick device on the back of a single handed electronic device. It is also possible to place such a rocker switch 509 input device onto any other type of portable electronic device, such as a telephone in a clamshell design, a portable digital assistant, a portable music device, etc.

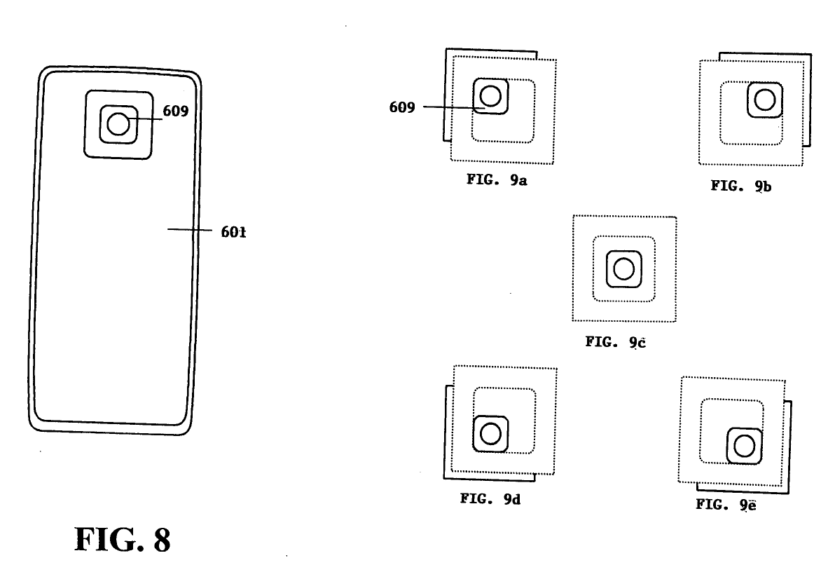

With reference to FIG. 8, a planar slide 609 mechanism mounted on the back of a phone 601 is illustrated. A portion of the slide 609 is exposed through a hole in the housing of the phone 601 and the edges of the slide 609 is concealed by the housing. The slide 609 has a raised surface 611 and a center indentation 613. The user places a finger over the center indentation 613 of the raised surface 611 and moves the slide 609 along a plane in any direction. An internal spring may center the slide 609 when it is not being used.

The movement of the planar slide switch 609 is illustrated with reference to FIGS. 9a-9e. Like the other input devices, the user moves the slide to the right side of the device to move the cursor 107 towards the right side of the graphical display 105 or moves the slide to the left to move the cursor 107 towards the left side of the display 105. The slide 609 may also have a click function that is actuated by pressing the center of the slide 609.

In an embodiment, the position of the slide 609 may correspond to the position of the cursor 107 in the display 105. If the slide 609 is moved to a lower corner towards the left side of the device, the cursor 107 is moved to the left lower corner of the display 105. If the slide 609 is centered, the cursor 107 moves to the center of the graphic display 105. In this embodiment, a spring is not used to center the slide 609 when it is not in use.

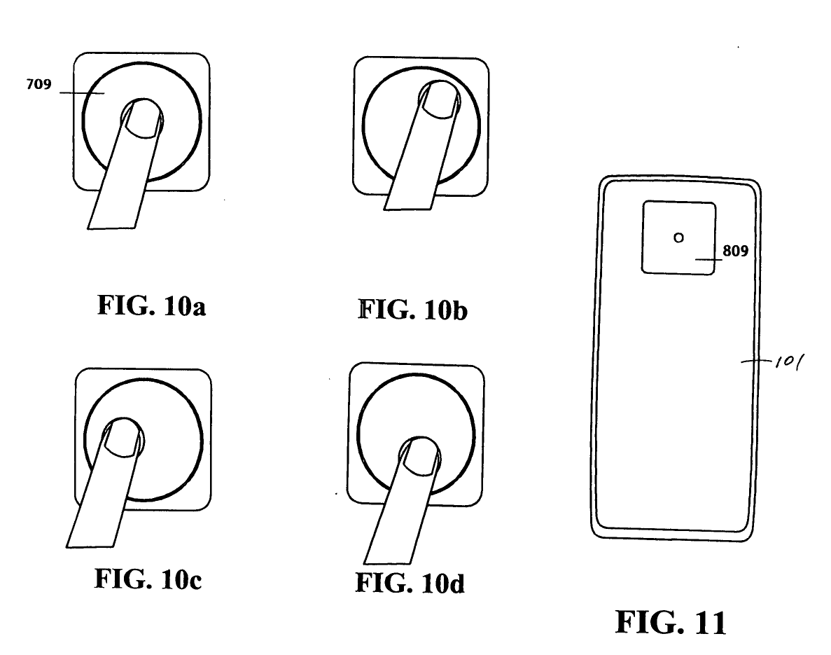

With reference to FIG. 10a-10d, the movement of a spherical slide 709 is illustrated. The spherical slide 709 is similar to the planar slide switch, except that the mechanism has a spherical surface. The spherical surface allows the user's finger to feel the rounded surface and sense the relative position. The center will feel flat while the edges will feel curved. A small indentation 713 or protrusion may be placed at the top center of the spherical slide 709. Like the planar slide 609, the spherical slide moves in response to movement of the user's finger tip that is placed on the top center of the slide 709. Movement of the slide 708 towards the right or left side of the device causes the cursor 107 to move towards the right or left side of the display 105, respectively. A spring may center the slide 708 when it is not used or alternatively, the slide 708 may remain in place after it has been moved by the user's finger tip. The spherical slide 709 may have a click function that is actuated by pressing the center of the spherical slide 709 inward.

Another embodiment of the invention is illustrated with reference to FIG. 11. In this embodiment, a touch pad 809 is placed on a surface of the device opposite the display or keypad. The touch pad 809 may have a small protrusion or indentation at the center of the touch pad 809 that helps the user locate the center of the pad 809. The protrusion is easily sensed by the tip of the index finger and allows the user to quickly place the index finger on the center of the pad 809. The touch pad 809 detects the position and movement of the user's fingertip in any direction over the touch pad 809. If the fingertip moves over the touch pad 809 towards the right side of the device, the cursor 107 moves towards the right side of the display 105 and if the fingertip moves towards the left side of the device, the cursor 107 moves towards the left side of the display 105.

The touch pad may have a click function which is actuated by a separate button adjacent to the touch pad 809 or on the side of the device. In this embodiment, the cursor 107 is positioned over the function, command or data of interest. This information is selected by pressing the button while the cursor is in the proper position.

In other embodiments, the touch pad 809 may have various other surface features. The center of the touch pad 809 may have a raised rectangular surface with a circular indentation or a small protrusion at the center. The touch pad 809 may have a plurality of small indentations or protrusions such as dots or squares that are arranged in a pattern and provide a tactile indication of the center of the touch pad 809. These patterns may be four dots forming a square and a single center dot. Five dots may also be arranged in a cross at the center of the touch pad. Various other patterns are possible.

Although, the touch pad is preferably a square or rectangular shape it is also possible to use a touch pad that is an elongated rectangle for up/down or side to side control. The touch may also be a cross which allows the user to only move the cursor up, down or sideways. In yet another embodiment, the touch pad may be a pattern of eight section oriented in a radial pattern from a center point. Each section allow the user to move the cursor up, down, sideways and diagonally.

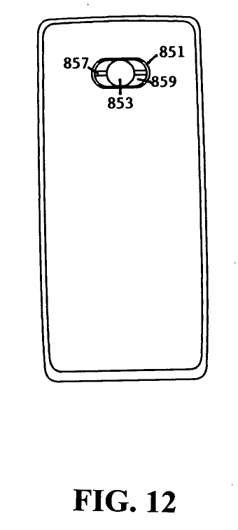

In yet another embodiment, an optical detector may be used as the input device. The optical sensor detects the movement of the user's fingers across the back of the device. The movement of the cursor 107 across the graphical display 105 is the same as that described in table 1 above. When the device is placed on a surface, it can be used as an optical mouse through wired or wireless communications with a local computer. A sensor detects when the device is placed on a planar surface and the mode of operation needs to be changed. The movement is the same as that described above in table 2. FIG. 12 illustrates another input device 851 used to control the portable digital device 101. The input device 851 has a roller 853 that is coupled to a rod 857 mounted in a channel 859 in the back of the portable digital device 101. The roller 853 can rotate about the rod 857 or slide across the rod 857 between the ends of the channel 859. To operate the input device 851, the user holds the device while placing the index finger on the roller 853. Sensors within the device 101 detect the rotation and sliding movements of the roller 853. In the preferred embodiment, the roller 853 is a sphere or cylinder having a center hole. Like the other input devices, when the index finger rotates the roller 853, the cursor 107 moves vertically towards the top of the screen 105 and sliding the roller 853 causes the cursor 107 to move horizontally in the screen 105. Rotating the roller 853 towards the top of the device 101 causes the cursor 107 to move towards the top of the screen 105. Sliding the roller 853 to the right side of the device causes the cursor 107 to move to the right side of the screen 105 and sliding the roller 853 to the left side of the device 101 causes the cursor 107 to move to the left side of the screen 105.

Although, the device has been described in terms of controlling a cursor on a graphical display, it is also possible for the cursor to be replaced with a highlight mechanism. In this embodiment, text or icons are shown on the graphical display. Each text or icon can represent a functional command, controls or other data files. At least one of the text or icons are highlighted. The highlighting can be changed by moving the input device. For example, if the input mechanism moves towards the right side of the device, the highlight will move to the text or icon to the right of the original highlight. If the input mechanism is held towards the right, the highlight will continue to move to towards the right to the next text or icon. The user can actuate the desired text or icon by moving the highlight to the desired location on the graphical display and using the click function of the input device.

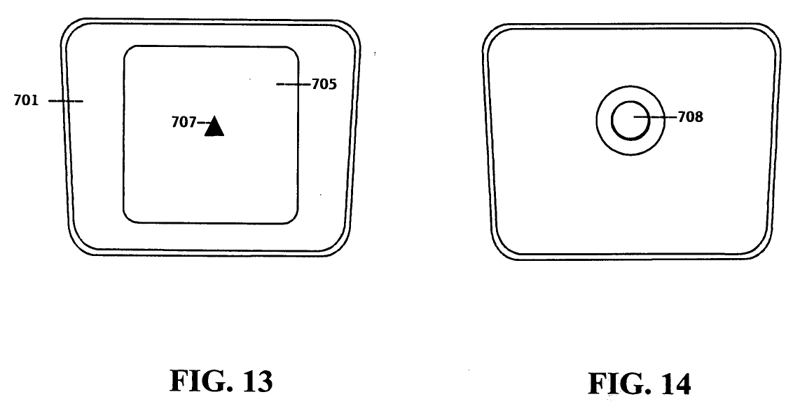

Although, the inventive input system has been described with reference to mobile phones it is also possible to use the inventive device with many other portable electronic devices. With reference to FIGS. 13 and 14, a portable video device 701 is illustrated. The front of the device 701 has a video screen 705 and a cursor 707 in the screen 705. An input device 708 is placed on the opposite side of the device 701. Although the illustrated input device 708 is a roller ball, any other type of input device may be used. By placing the input device 708, the area available for the graphical display is expanded.

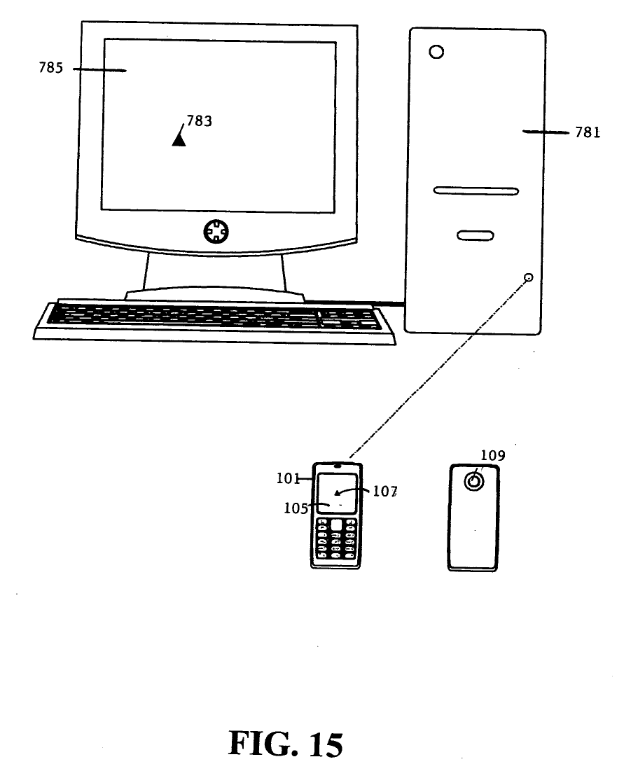

With reference to FIG. 15, the inventive device 101 may include wireless communications capabilities such as WiMAX, WiFi and BlueTooth for networking with one or more computers 781. The device 101 may be configured to function as a wireless controller for the computer 781. The movement of the input device 109 may control the movement of a cursor 783 on the screen 785 of the computer 781 and the movement of a cursor 105 on the display 105.

In an embodiment, the device 101 may incorporate internet browser capability that uses a wireless network. In these embodiments, the portable electronic device includes a web browser program and a graphical display 105 that has sufficient size and resolution to display unfiltered web text and graphics. The inventive device is particularly useful for portable web browser applications because the graphical display 105 can use more space of one side of the device 101 while the input device 109 is placed on the opposite side. The device may also incorporate voice recognition so that user can input text verbally, rather than using a keyboard device.

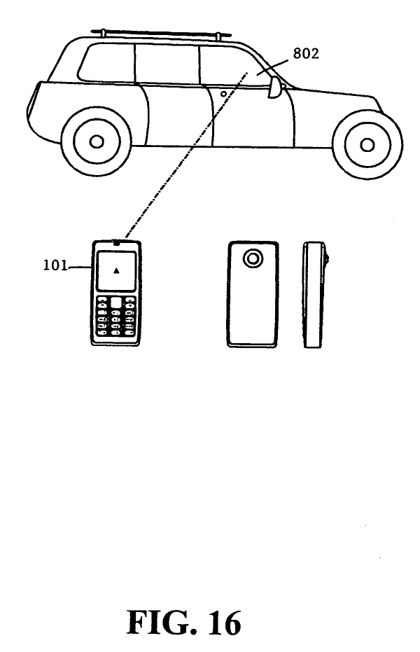

In addition to wireless internet access, the device may also include wireless communications with other devices. A common protocol for this type of proximity detection and communication is BlueTooth. With reference to FIG. 16, a Bluetooth device such as a car 802 may recognize the presence of the device 101 based upon the detection of a signal emitted by the portable electronic device 101. The system could then allow a user to start and operate the car 802 without the use of a normal key. The portable electronic device 101 can also forward the phone functions into the car's audio system so that the any incoming call can be transmitted over a speaker phone interface in the car 802. The system would automatically turn down or turn off any audio programs that were being played so that the user can communicate in a normal voice volume without having to hold and operate the phone while driving. The system would also allow outgoing calls to be made in a similar hands free mode of operation.

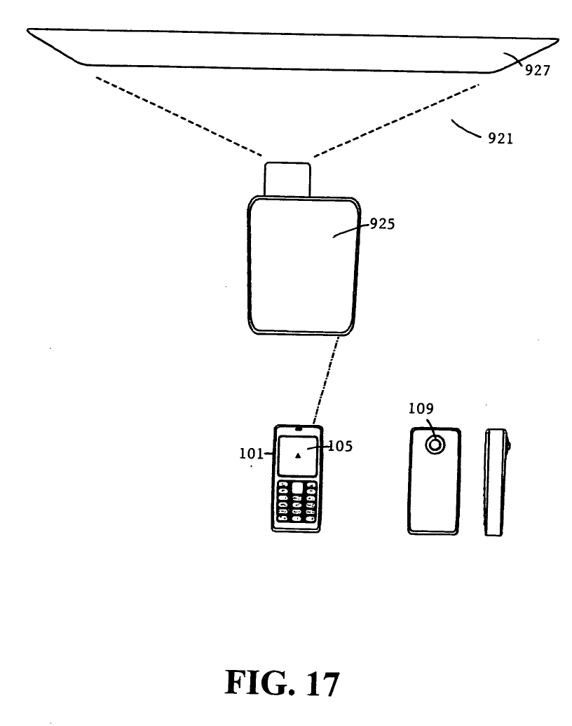

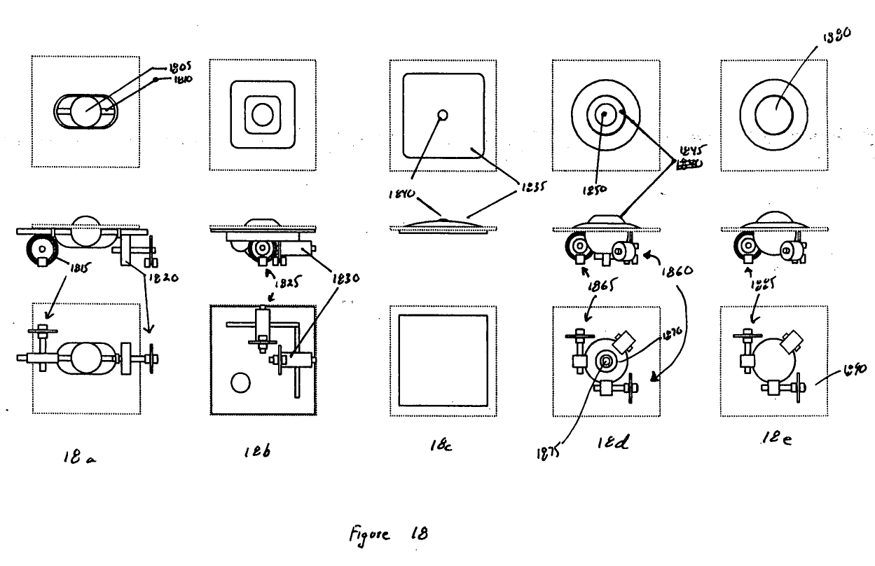

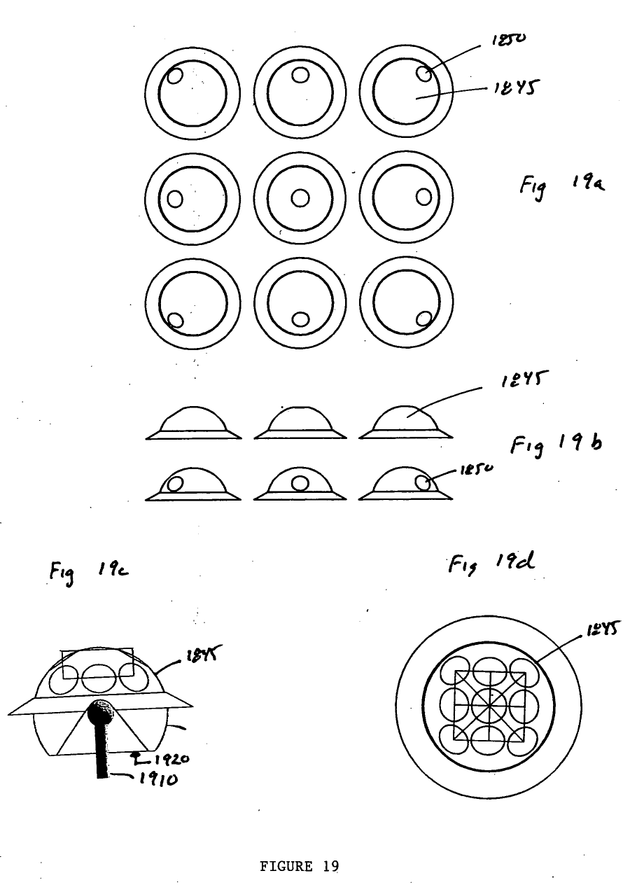

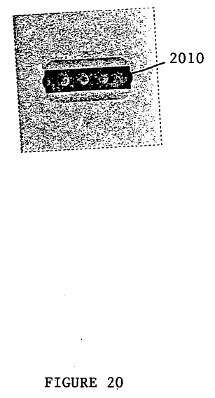

With reference to FIG. 17, the inventive device 101 may also wirelessly communicate with a presentation system 921 used to display information at a meeting. The device 101 and input device 109 can take the place of a wireless mouse and provide a second graphical display 105 for the user. This may be particularly useful when used with presentation applications such as Microsoft Power Point presentations. Normally, a video projector 925 is connected to a computer and shows the slide/video presentation on a screen 927 to an audience. By using the inventive portable digital device 101, the user can store all presentation data in the internal or removable device memory and transmit the information to the presentation system 921 as it is needed during the presentation. The device 101 can also control the presentation. The user can see the graphical display 105 and know the location of the cursor on the screen 105 while facing the audience. This allows the user to move more freely around the stage and allows enhanced interaction between the speaker and the audience.

The placement of the input device opposite the graphical display is also very space efficient. Many existing devices have an input and graphical display on a front side while the back side of the device is only functional as a housing to protect the device or providing a cover for a battery stored within the device. For example, mobile telephones have a keyboard and graphical display positioned so that user can see both while using the phone. Similarly, portable electronic music players and portable video equipment have a graphical display and an input device that can be seen simultaneously. By placing the input device on an unused surface, the area available for the graphical display can be expanded.

The inventive portable electronic device differs from the prior art because the graphical display is on one side of the device and the input device is on the opposite side. Because the input device is not seen by the user during normal operations, the graphical display is responsive to the input device. In an embodiment, the graphical display has a visual indicator such as a high light or a cursor.

While the present invention has been described in terms of a preferred embodiment above, those skilled in the art will readily appreciate that numerous modifications, substitutions and additions may be made to the disclosed embodiment without departing from the spirit and scope of the present invention. Those skilled in the art will readily appreciate that the present invention is in no way limited to mechanisms described above. For example, other controllers of other types than these enumerated may be used such as: the eraser type controller used in some notebook computers. In yet another embodiment, the portable electronic device may be held with two hands and have two index finger input mechanisms, one for each finger. Further, while the inventive devices have the ability to move the cursor and highlight in two degrees of movement, it can also be used for more limited control such as: vertical or horizontal scrolling through multiple command listings viewed on the display. It is intended that all such modifications, substitutions and additions fall within the scope of the present invention which is best defined by the claims below.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A portable electronic device adapted to be held in one hand having:
a graphics display on one surface; and
a finger-actuable controller on an opposite surface for detecting movement of a user's fingertip generally parallel to the opposite surface;
wherein the graphics display is responsive to actuation of the controller.

24. A portable electronic device adapted to be held in one hand as in claim 23 wherein the graphics display displays a visual indicator that moves in response to actuation of the finger-actuable controller.

25. A portable electronic device adapted to be held in one hand as in claim 24 wherein the visual indicator moves in the same direction as the movement of the finger-actuable controller.

26. A portable electronic device adapted to be held in one hand as in claim 25 wherein the finger-actuable controller detects motion of the user's finger tip in a plane.

27. A portable electronic device adapted to be held in one hand as in claim 26 wherein the finger-actuable controller further provides a select signal in response to extra finger pressure.

28. A portable electronic device adapted to be held in one hand as in claim 26 wherein the finger-actuable controller includes a touch pad.

29. A portable electronic device adapted to be held in one hand as in claim 28 wherein touch pad includes a center dimple.

30. A portable electronic device adapted to be held in one hand as in claim 26 wherein the finger-actuable controller includes a joy-stick ball.

31. A portable electronic device adapted to be held in one hand as in claim 30 wherein the joy-stick ball includes a recess adapted to receive a user's finger tip.

32. A portable electronic device adapted to be held in one hand as in claim 26 wherein the finger-actuable controller includes a slide mechanism that can be moved in a plane.

33. A portable electronic device adapted to be held in one hand as in claim 32 wherein the slide mechanism has a receptacle adapted to receive a user's finger tip for providing friction between the slide mechanism and the user's finger tip.

34. A portable electronic device adapted to be held in one hand as in claim 26 wherein the finger-actuable controller includes a track ball.

35. A portable electronic device adapted to be held in one hand as in claim 34 wherein the track ball has a receptacle adapted to receive a user's finger tip for providing friction between the slide mechanism and the user's finger tip.

36. A portable electronic device adapted to be held in one hand as in claim 26 wherein the finger-actuable controller includes a ball on a rod.

37. A portable electronic device adapted to be held in one hand as in claim 36 wherein the finger-actuable further provides a select signal in response to extra finger pressure.

38. A portable electronic device adapted for being held and operated with one hand comprising:
a housing having a first surface and a second surface, wherein the second surface is substantially opposite the first surface;
an input device that detects a movement of a user's finger tip over the second surface;
a graphics display disposed on the first surface for displaying a visual indicator, the movement of the visual indicator in the graphics display being responsive to movement of the user's finger tip detected by the input device; wherein if the input device detects the user's finger tip moving towards a first side of the housing, the microprocessor moves the visual indicator in the graphics display towards the same side of the housing.

39. A display system including a graphics display and a portable electronic device adapted to be held in one hand, the portable electronic device having:
a first surface adapted to be viewed by the user during operation;
a transmitter for transmitting a graphics control signal to the remote graphics display; and
a finger-actuable controller mounted on a surface opposite the first surface and positioned so as to be operated by the user's index finger for detecting movement of a user's fingertip generally parallel to the opposite surface;
wherein the graphics signals are responsive to actuation of the controller.

40. A display system as in claim 39 wherein the graphics display displays a visual indicator that moves in response to actuation of the finger-actuable controller.

41. A display system as in claim 40 wherein the visual indicator moves in the same direction as the movement of the finger-actuable controller.

42. A display system as in claim 41 wherein the finger-actuable controller detects motion of the user's finger tip in a plane.

43. A display system as in claim 42 wherein the finger-actuable controller further provides a select signal in response to extra finger pressure.

44. A display system portable as in claim 42 wherein the finger-actuable controller includes a touch pad.

45. A display system as in claim 44 wherein touch pad includes a center dimple.

46. A display system portable as in claim 42 wherein the finger-actuable controller includes a joy-stick ball.

47. A display system as in claim 46 wherein the joy-stick ball includes a recess adapted to receive a user's finger tip.

48. A display system portable as in claim 42 wherein the finger-actuable controller includes a slide mechanism that can be moved in a plane.

49. A display system as in claim 48 wherein the slide mechanism has a receptacle adapted to receive a user's finger tip for providing friction between the slide mechanism and the user's finger tip.

50. A display system as in claim 42 wherein the finger-actuable controller includes a track ball.

51. A display system as in claim 50 wherein the track ball has a receptacle adapted to receive a user's finger tip for providing friction between the slide mechanism and the user's finger tip.

52. A display system as in claim 42 wherein the finger-actuable controller includes a ball on a rod.

53. A display system as in claim 52 wherein the finger-actuable further provides a select signal in response to extra finger pressure.

54. A portable electronic device adapted to be held in one hand and having:
a keypad on one surface; and
a finger-actuable controller on an opposite surface for detecting movement of a user's fingertip generally parallel to the opposite surface; the device further comprising a wireless communicator for communicating graphics positioning signals responsive to the controller to the remote graphics display.

55. A portable electronic device adapted to be held in one hand and having:
a keypad and a graphics display on one surface; and
a finger-actuable controller on an opposite surface for detecting movement of a user's fingertip generally parallel to the opposite surface;
the graphics display further comprising a visual indicator which moves in response to movement of the controller.

56. A portable electronic device adapted to be held in one hand and having:
a graphics display on one surface; and
a finger-actuable scrollable controller on an opposite surface for detecting movement of a user's fingertip generally parallel to the opposite surface;
the graphics display further comprising scrollable information that scrolls in response to movement of the controller.
